(19) United States
(12) Patent Application Publication
(10) Pub. No.: US 2009/0188535 A1
(43) Pub. Date: Jul. 30, 2009

(54) Wash Pad and Wash Fluid Containment System

(76) Inventors: Shannon L. Taylor, Vancouver, WA (US); Richard W. Frederick, Vancouver, WA (US); Bernie L. Larson, Vancouver, WA (US); Paul W. Linton, Camas, WA (US)

Correspondence Address: SHERIDAN ROSS PC, 1560 BROADWAY, SUITE 1200, DENVER, CO, 80202, US

(21) Appl. No.: 12/032,562

(22) Filed: Feb. 15, 2008

Related U.S. Application Data
(60) Provisional application No. 60/901,953, filed on Feb. 16, 2007.

(51) Int. Cl. B60S 3/00; B08B 3/02

(52) U.S. Cl. 134/104.2; 137/314

(57) ABSTRACT

A wash pad and wash fluid containment system upon which items such as vehicles or equipment are positioned and supported for collecting wastewater occasioned when washing the items, the system having various combinations of the following: a central trench, left and right side wash pad sections positioned on opposite sides of the central trench, the left and right side wash pad sections preferably being of identical configuration and interchangeable, each side wash pad section having a sloped surface for directing wastewater toward the central trench; a partial side wall enclosure assembly disposed about an outer perimeter of three sides of the wash pad; integrated pressure washer system mounted on the rear wall; a retractable cover assembly including a tarp wrapped on a roller mounted on the rear wall; side wall extension system extending above the side walls including a frame and tarp sections hanging on the frame.

### RELATED APPLICATION DATA

This application claims priority to provisional application No. 60/901,953 filed Feb. 16, 2007 hereby incorporated by reference.

### BACKGROUND

The field of the present invention is directed to wash fluid containment systems such as used for containing fluids when washing vehicles or other equipment.

Heretofore, there have been various attempts to construct a wash fluid containment system. Such systems are either movable structures or permanent, installed structures. The permanent structures are generally bulky or difficult to erect while the movable structures tend to be not particularly versatile and typically require heavy equipment for transporting.

The present inventors have recognized various limitations in the prior systems and the desirability for an improved system.

### BRIEF DESCRIPTION OF THE DRAWINGS

FIG. 1 is a front top perspective view of a wash fluid containment and water treatment system according to a preferred embodiment.

FIG. 2 is partially exploded view of the wash pad portion of FIG. 1.

FIG. 3 is a partially exploded view in cross-section of the central trench portion of the wash pad of FIG. 2, on an enlarged scale.

FIG. 4, comprising FIGS. 4A, 4B, 4C is a fully exploded view of the wash pad of FIG. 2.

FIG. 4D is a detailed exploded view, on an enlarged scale, of the ramp hinge connector of FIG. 4C.

FIG. 5 is an exploded view of the tarp cover assembly and hose reel cover assembly of the wash pad system of FIG. 2.

FIG. 6 is a perspective view of the wash pad of FIGS. 1-2 with the tarp cover in the covering position, extending over the wash pad.

FIG. 6A is a detailed view of the tarp rod connecting system of FIG. 6.

FIG. 7 is an alternate preferred configuration for the tarp cover.

FIG. 8 is a detailed view of the tarp cover crank system for the wash pad assembly of FIG. 2.

FIG. 9 is an exploded view of an optional sprayer assembly for the wash pad assembly of FIG. 2.

FIG. 10 is a perspective view of the wash pad system of FIGS. 1-4 further including an optional side wall extension system.

FIG. 10A is a detail of a portion of FIG. 10 illustrating details of the tarp section engaging the hanging hook.

FIG. 11 is an exploded perspective view of the wash pad system of FIG. 10 including the optional side wall extension system.

FIG. 12 is a perspective view of the wash pad system of FIGS. 1-4 assembled into a compacted shipping mode.

FIG. 13 is a side elevation view of the compacted wash pad of FIG. 12.

FIG. 14 is a front side elevation view of the compacted wash pad of FIG. 13 take along line 14-14.

Additional aspects and advantages will be apparent from the following detailed description of preferred embodiments, which proceeds with reference to the accompanying drawings.

### DETAILED DESCRIPTION OF PREFERRED EMBODIMENTS

Preferred embodiments will now be described with reference to the drawings. To facilitate description, any element numeral representing an element in one figure will represent the same element in any other figure.

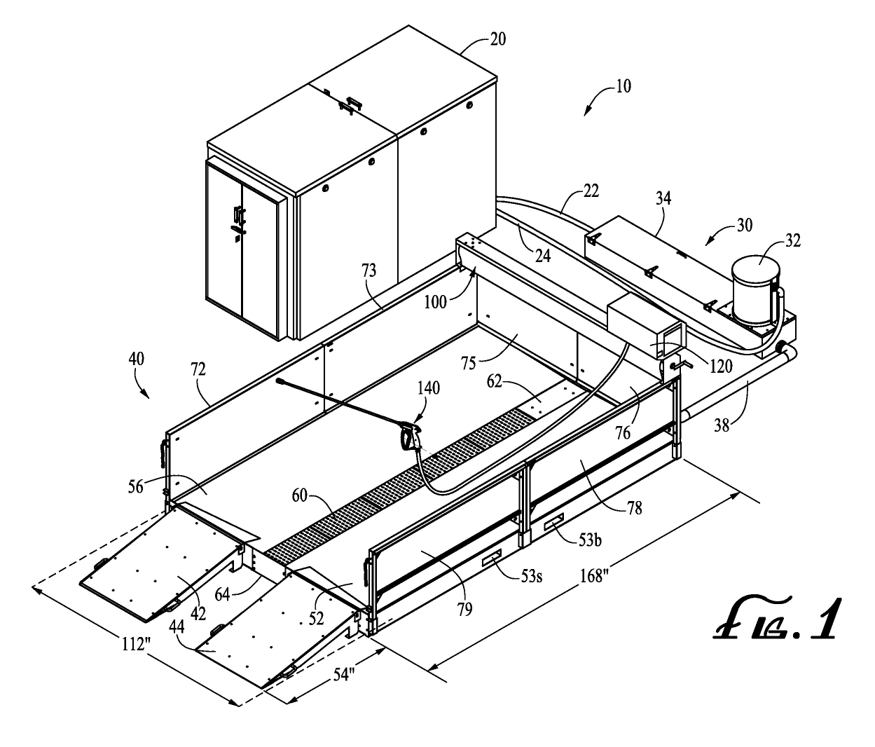

FIG. 1 illustrates a wash water containment and water treatment system 10 according to a preferred embodiment. The combined system 10 includes a wash pad 40, a sump 30, and a water treatment system 20. A vehicle or other piece of equipment to be washed may be moved or driven onto the wash pad 40. As the equipment is washed via the sprayer assembly 140, wastewater is directed inwardly by the sloped surfaces of the right and left wash pad sections 52, 56, collected via central trench or trough 65, and then transferred via pipe 38 to the sump 30. The sump 30 comprises a sludge separator 32 and a holding tank 34 including a weir (not shown). The wastewater from pipe 38 must pass over the weir in the holding tank 34, the weir capturing heavy solids, and the wastewater thereafter enters the treatment system 20 via hose 22. Recycled/treated water from the system 20 is returned to the wash pad area for use by the sprayer assembly 140. Sludge waste from the treatment system 20 is purged into the sludge separator 32 via hose 24. The sludge separator 32 includes a bucket-shaped filter screen that filters/separates the sludge waste and other particulates from the water, the water passing through the filter and into the holding tank 34. The sludge waste (which may be referred to as solids) may be manually removed from the sludge separator 32.

The figures are drawn generally to scale and the size dimensions for the wash pad assembly 40 illustrated in FIG. 1, namely 112 inches (260 cm) wide by 168 inches (430 cm) long, constitute a preferred size of wash pad.

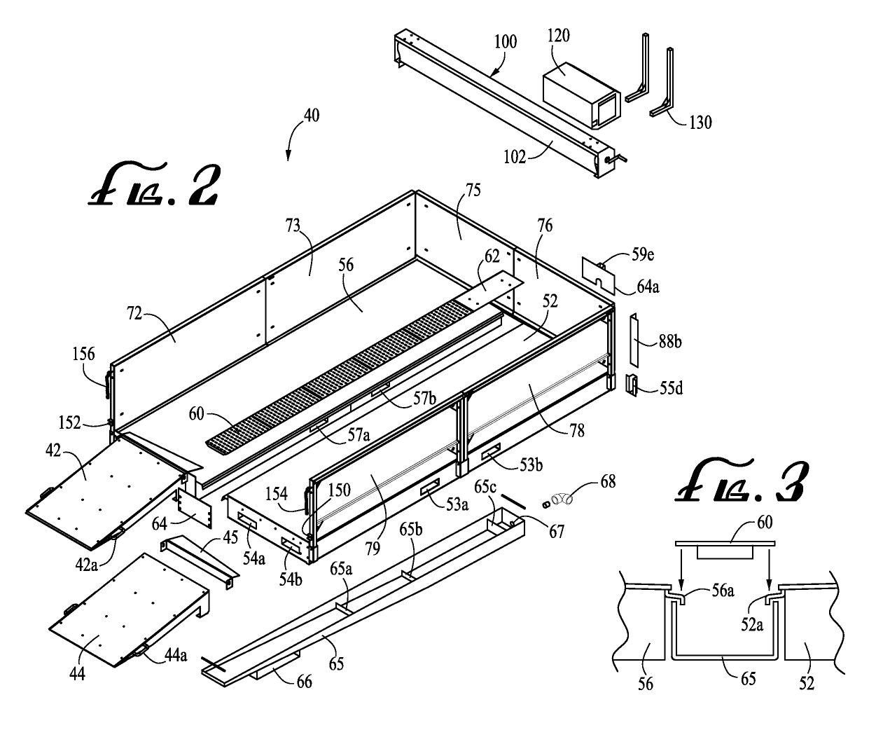

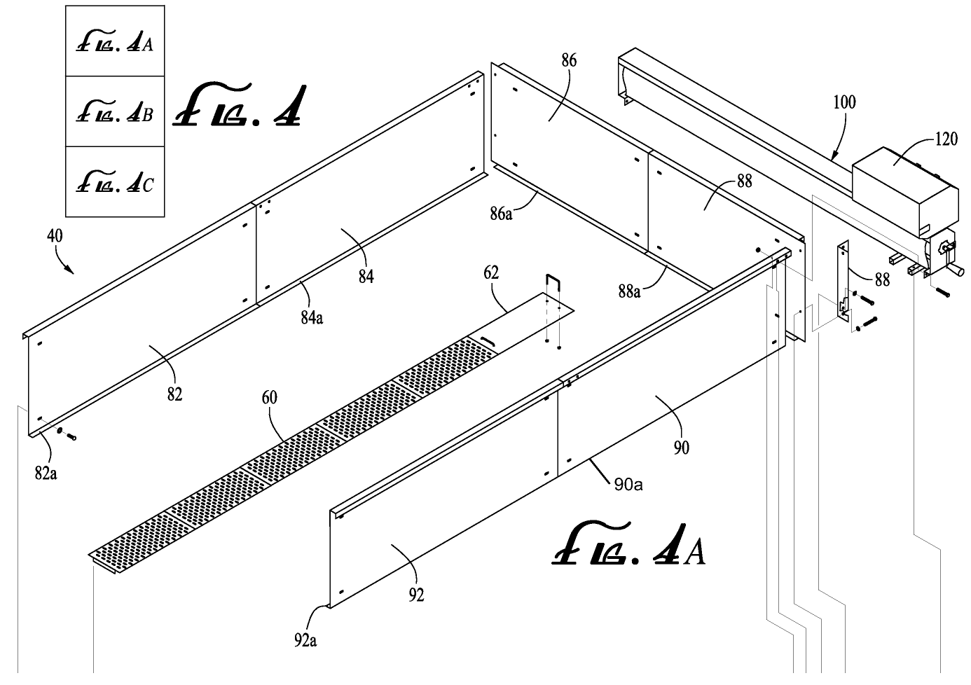

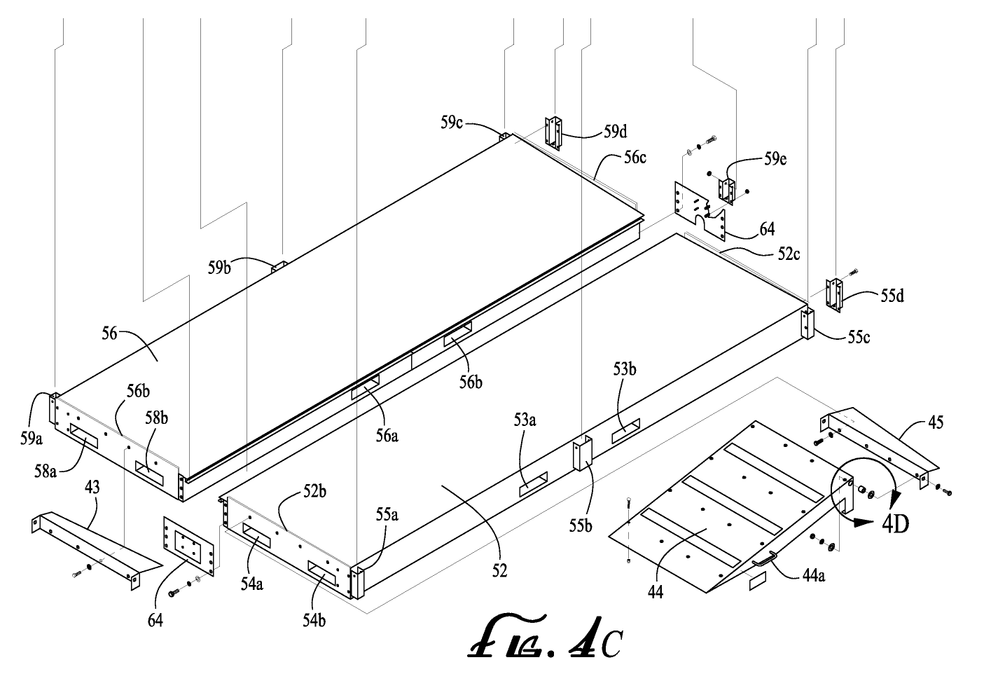

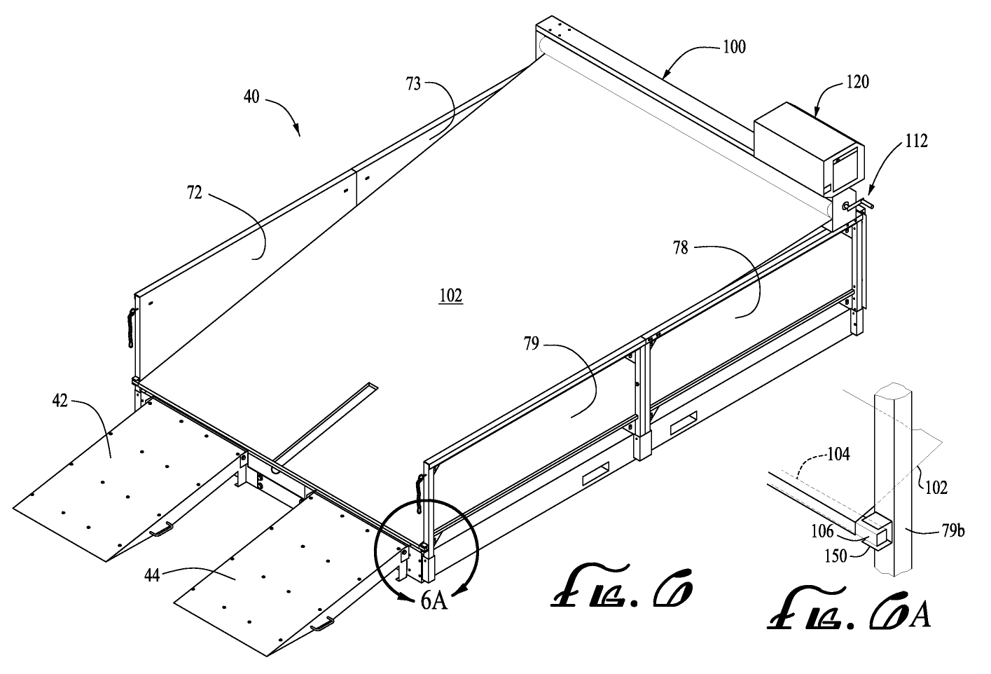

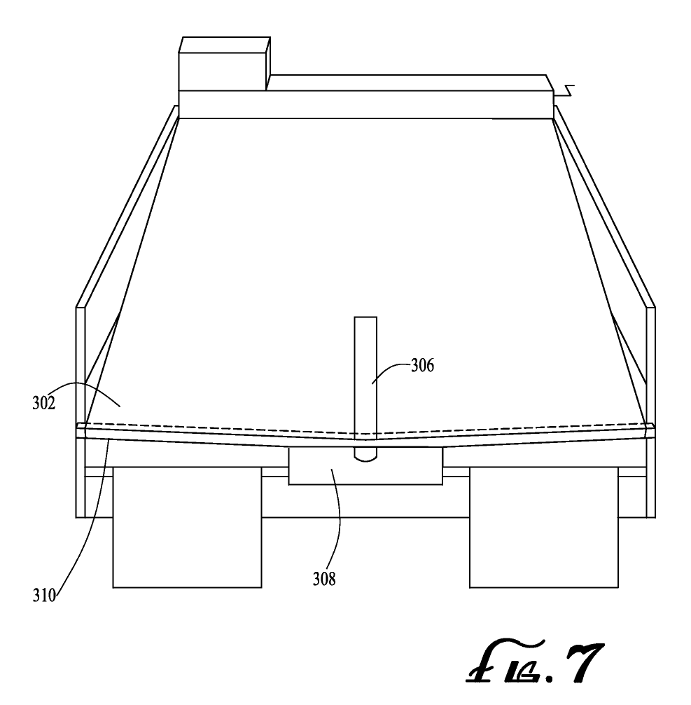

FIGS. 2-8 illustrate details of the wash pad 40. The wash pad 40 includes right and left pad sections 52, 56. The pad sections 52, 56 are of identical configuration, each having a top sloped surface for diverting water from the outer lateral sides toward the center trench 65. The right pad section 52 includes an extension 52a (see FIG. 3) extending along from the top surface of the lower sloped edge of the pad over the sidewall of the central trench 65. The central trench 65 is disposed between the right and left wash pad sections 52, 56 and itself has a downwardly-sloped internal bottom surface (from one longitudinal end to the other) for diverting or directing water from the right and left wash pad sections rearward to the rear end of the wash pad 40. The trench 65 has a series of weirs 65a, 65b and a screen 65c designed to trap large debris within the trench and prevent it from reaching the lower outlet 67. The trapped debris may be cleaned from the trench 65 by removing the perforated grating 60 and solid grating section 62 and then cleaning out the debris trapped in the trench 65. The sloping angle of the trench 65 is maintained by a block support 66 at the front end thereof. The trench outlet 67 is connected to the hose 38 (see FIG. 1) via a fitting 68. The extensions 52a, 56a extend over the upper side edges and direct water off the top surfaces of the right and left wash pad sections 52, 56 and into the trench 65. The right wash pad section 52 includes holes 53a, 53b in the lateral side and slots/holes 54a, 54b (fork lift openings) in the end side for accommodating the forks of a forklift truck for moving the pad section during assembly and also for disassembling and transporting the pad section when stacking for transport. The left wash pad section 56, being of like configuration, includes slots 57a, 57b in the lateral side and slots 58a, 58b in the front end side. The left wash pad section 56 also includes similar slots (not visible in the figure) on the rear end side and the outer lateral side; the right wash pad section 52 also includes similar slots (not visible in the figure) on the rear side and on the inner lateral side. The left 56 and right 52 wash pad sections are thus identical and interchangeable. Moreover, since the wash pad sections 52, 56 each have fork lift slots/openings on all four sides, a fork lift is able to engage a slot for lifting the wash pad section from any direction.

The right pad section 52 includes end plates 52b, 52c attached at its front and rear ends. The end plates are rectangular, having a height such that the top surface of the end plate 52b is essentially flush with the higher outer surface of the pad, and at the inner central portion of the top surface of the pad, the top surface of the end plate 52b is above the surface. The same is true for end plate 52c. Thus, water on the top surface of pad section 52 is prevented from spilling over the front or rear ends of the pad section 52. Similarly, the left pad section 56 includes end plates 56b, 56c of similar construction. An end plate is affixed to each end of the wash pad sections and need not be removed when the remaining elements of the wash pad system are disassembled for transport. The end plates 52b, 52c, 56b, 56c include holes aligned with respective holes 54a, 54b, etc. in the wash pad sections 52, 56.

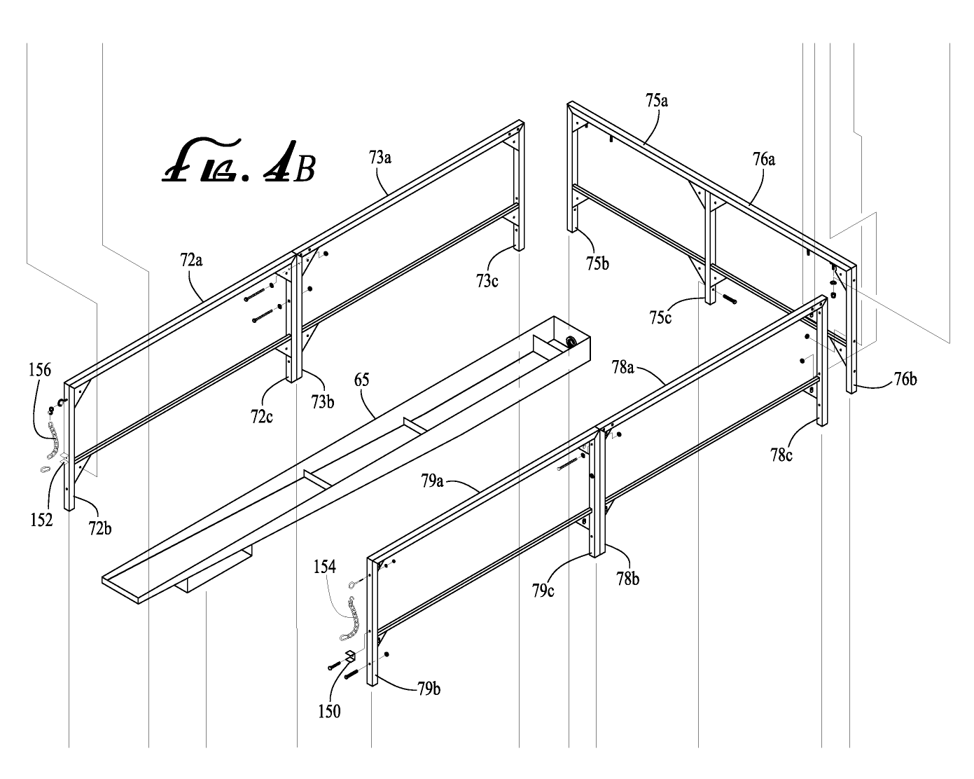

To assemble the wash pad assembly 40, the trench 65 is set in a desired location. In a preferred configuration, the trench 65 is reversible. Depending on the orientation of the trench 65, wastewater may be drained either forwardly or rearwardly for connection to the sump hose 38. FIG. 2 illustrates the trench 65 oriented for drainage in the rearward direction with the trench exit 67 by the rear wall 75/76. Once the trench 65 is in the desired position, the right and left wash pad sections 52, 56 are set in place with the extensions 52b, 56b extending over the side walls of the trench 65 as shown in FIG. 3. The trench endcap 64 is a rectangular end plate of the same height as the other end plates 52a, 56a, covering the gap therebetween. A rear side endplate 64a has an opening or notch corresponding to the exit port 67 and the trench 65. A ramp connector 43 attaches to the end of the left ramp section 56 extending over the top edge of the end plate 56b. The ramp connector 43 also includes a hinge connector for attachment of the left ramp 42 via pin connectors. Similarly, on the right wash pad section 52, a ramp connector 45 is provided which attaches to the end of the right wash pad section 52 extending over the top edge of the end plate 52b. The ramp connector 45 includes a hinge connection for attachment to the ramp 44. Details of the hinge connector are illustrated in FIG. 4D whereby a bolt 45c is secured by a nut 45d with a bushing or spacer 45a mounted on the bolt 45c. The bushing 45a serves to permit rotation or pivoting of the ramp section 44 whereby the bolt 45c is operative as a hinge mechanism. The ramp 44 is rotatable about 90° from the position shown in FIG. 1 to a position pointing vertically. Once in the vertical (closed) position, the ramp 44 is secured by a locking chain 154 and pin. The ramp 44 is provided with handles 44a for assisting a user in moving the ramp, such as during assembly, and for rotating it between the open and closed positions.

The perforated grate or grating 60 is installed over the trench 65 extending laterally between the left and right wash pad sections 52, 56. The grating 60 has perforations for allowing the water flowing downward from the left and right wash pad sections 52, 56 to pass through and into the trench 65. The grating 60 rests on the pad extensions 52a, 56a and is generally flush with the top surface of the adjacent wash pad sections. The grating 60 preferably provides a secure surface for users walking around the wash pad. The grating 60 may comprise a plurality of separate (separable) sections, the grating 60 is illustrated in FIG. 2 as being composed of five sections. The perforations are preferably of a desired size large enough to allow for passage of the water into trench 65, but small enough to prevent passage of larger size debris. Such debris may then be removed from the pad by sweeping or other manual collection. A solid grating section 62 is positioned at the back end of the wash pad over the trench 65. The solid grating diverts water toward the center of the wash pad and through the perforated grating 60 and into the trench 65 such that water and any debris must pass through the screen 65c.

In operation, a vehicle is driven or otherwise rolled up the ramps 42, 44 and onto the wash pad sections 52, 56. The wheels of the vehicle straddle the gap between the ramps 42, 44 and the central grating 60. Unlike a wash pad configuration having a single wash pad section with a trench located on one side of the pad, requiring the pad to have a sharp angle of declination from one side of the entire wash pad to the other, this two-pad system 40 configured with two wash pad sections 52, 56, a central grating 60 and trench 65 allows the water to have a shorter path to the trench. Moreover, the vehicle will stand level (i.e. horizontal) as it straddles the grating 60 as opposed to being at an uneven angle (i.e. non-horizontal) were the drainage trench located on one side of the wash pad.

In order to prevent splashing of water off of the wash pad sections 52, 56, the wash pad system 40 is provided with a side wall assembly around the outer perimeter of three sides of the pad. Support brackets are disposed around the outer periphery of the ramp pad sections for accommodating the posts of the side walls. As will be described in more detail below, each of the side wall sections 72, 73, 75, 76, 78, 79 is formed via a rectangular post frame having tubular sections which are installed into the side support brackets with side panels attached to the frame sections. Side wall sections 72, 73 are disposed on the lateral side of the left wash pad section 56; side wall section 75 is disposed on the rear end of the left pad section 56; side wall section 76 is disposed on the rear end of right pad section 52; and right side wall sections, 78, 79 are disposed on the lateral side of the right pad section 52. Details of each of the side wall sections are described in the following.

Front-left side wall section 72 is comprised of a tubular frame section 72a with two leg sections 72b, 72c. Leg 72b is inserted into the bracket 59a, and leg 72c is inserted into bracket 59b. Side panel 82 is attached to the frame section 72a via bolts. Similarly, rear-left side wall section 73 includes frame section 73a with left and right leg portions 73b, 73c, the leg portions being inserted into the brackets 59b and 59c, respectively. Panel section 84 is attached to the frame section 73a. The rear wall sections 75, 76 are formed with a common frame 75a, 76a, with three leg portions, 75b, 75c and 76b, which are disposed in respective brackets 59d, 59e and 55d. Panel section 86 is attached to the left side frame section 75a, and panel section 88 is attached to the right side frame section 76a.

The right side wall sections 78, 79 are similar in construction to the left side wall sections 72, 73. Front-right side wall section 79 includes a frame portion 79a with left and right leg portions 79b, 79c, that are insertable into brackets 55a, 55b. Panel section 92 is installed onto the frame section 79a via bolts or other suitable fasteners. Similarly, front-left wall section 78 is comprised of a frame section 78a with left and right leg portions 78b, 78c being insertable into brackets 55b, 55c, respectively. The panel section 90 is attached to the frame section 78a via suitable connectors.

The lower edge of each panel section 82, 84, 86, 88, 90, 92 includes an inwardly and downwardly angled ledge lower lip portion 82a, 84a, 86a, 88a, 90a, 92a, respectively. The lower lip portion 90a of panel section 90 is not fully visible in FIG. 4A but is of similar configuration. Using panel section 82 as an example, the lower lip portion 82a extends inwardly from the vertical surface of the panel section 82 (the primary surface of the panel section 82 being vertical when installed as a side wall for the wash pad). The lip portion 82a is downwardly angled at a similar angle to the slope of the left wash pad section 56. Thus, water splashed on the surface of the panel 82 travels downward on the panel and is directed radially inward along the downward slope of the wash pad section 56 toward the trench 65. The overlap between the lip portion 82a and the upper wash pad surface inhibits water from passing outward from the inner volume of the wash pad past the wall assembly 72 via any gap between the lip 82a and the top surface of the left wash pad section 56. Alternately or additionally, a flexible seal may be installed between the two adjacent surfaces.

The wash pad assembly 40 is further provided with a retractable cover system 100 and a retractable pressure washer hose and reel enclosure system 120. The retractable cover system 100 includes a cover or tarp section 102, which in its retracted position, includes a tarp rolled up on a roller or post 105 disposed within an enclosure 110. The post 105 is supported within the end sections of the enclosure 110 and is connected to a shaft section 115 of the crank 112. The crank 112 includes a handle 113, ratchet mechanism 114, and a pall 119. In operation, the pall 119 engages the ratchet mechanism 114 to lock the crank position as further detailed below. The tarp hand crank 112 may be installed on either end of the enclosure 110.

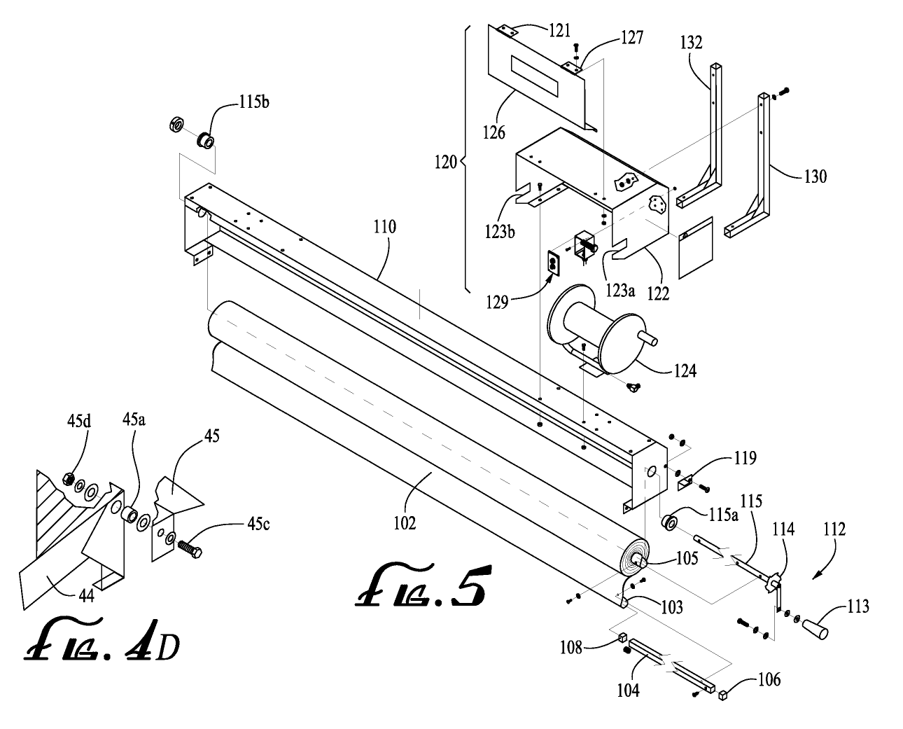

The cover 102 is operative to cover a predominant portion of the wash pad when the wash pad is not in use, thereby preventing rain water from being collected by the wash pad system, thereby unnecessarily loading the water treatment system 20. The end of the cover 102 has a loop section 103 into which a rod 104 is installed, held in position by end caps 106, 108. The width of the cover or tarp section 102 is about the same width of the wash pad between side wall 73 and side wall 78. The rod 104 is wider than the width between the wall sections, and portions of the rod are allowed to slide along the top surface of the side walls 72/73, 78/79 as the tarp is extended to the open end of the wash pad. The ratchet mechanism 114 is a one-way ratchet, and the pall 119 must be rotated clear of the teeth of the ratchet 114 so as to be disengaged from the ratchet mechanism 114. Once the tarp 102 reaches the fully extended position past the outer corners of the wall sections 72, 79, the rod section may be lowered and then inserted into brackets 150, 152. The brackets 150, 152 are attached to posts 79b, 72b respectively. As particularly visible in the enlarged view of FIG. 6A, the rod 104 and end caps 106, 108 are rectangular and thus, when inserted into the brackets 150, 152, the rod 104 does not rotate. By rotating the rod 104 approximately one-quarter to one-half rotation before insertion into the brackets 150, 152, a smooth runoff geometry of the tarp surface may be created over the top of the rod 104 for the tarp 102. Once in the position within the brackets 150, 152, the user may tighten the tarp into a taut condition by rotating the crank arm 113 in the opposite direction, (counter-clockwise) and then once the desired tautness is reached, the pall 119 is rotated into place against the ratchet mechanism 114, the pall engaging the teeth of the ratchet thereby locking the ratchet in place and preventing further rotation of the crank 112 thereby maintaining the desired tautness of the tarp. In this condition, the tarp assumes a downward angular slope from the closed end next to the enclosure 110 to the end next to the ramps 42, 44, thereby enabling/enhancing water runoff/drainage off the tarp 102, past the rod 104 and off and clear of the wash pad without any pools of water forming on top of the tarp 102.

FIG. 7 illustrates another preferred tarp system wherein the tarp 302 includes a central channel or notch 306. The central channel 306 may be located at the end of the tarp 302 (with a length on the order of 30 inches as illustrated) or alternately the channel 306 may extend further, up to the full length of the tarp. A square end tube 310 (similar to the rod 104 of the previous embodiment) is installed in the tarp loop section. The tube 310 is provided with a downward bend in the middle, thereby forming a slight V-shape. In combination, the V-shaped tube 310 and the tarp channel 306 directs the water flow radially inwardly toward the center of the tarp 30. The tarp 302 is then provided with a end drain flap 308 for directing the flow of water outwardly and away from the pad thereby preventing water draining off the tarp from flowing onto the pad. In this embodiment with the V-shaped tube 310, the tube 310 need not rotated when inserting into the brackets 150.

The wash pad assembly 40 may also include an integrated pressure washer system comprised of a hose reel and cover assembly 120 and sprayer assembly 140. The sprayer assembly 140 includes a trigger valve mechanism 142, a wand 144 and nozzle 146 attached to a pressure washer by a hose 148. The hose 148 is wound onto a hose reel 124 that is disposed within a hose reel housing 122. The housing 122 includes a door assembly 126, which pivots upwardly via hinges 127, 128. The housing 122 is mounted to the top of the enclosure 110 and supported with brackets 130, 132 that are fastened to the rear wall. The hose reel housing 122 includes notches 123a, 123b that accommodate the insertion of the sprayer assembly 140. Thus, when not in use, sprayer assembly 140 may be inserted within the slots 123a, 123b and the hose cover door 126 is rotated downward into place, securing the wand assembly 140 in place. The door 126 and hose reel cover 122 may be provided with a locking mechanism such as a padlock (not shown) for locking the door 126 for securing not only the hose and hose reel 124, but also the sprayer assembly 140, and the pump switch 129. The pump switch 129 is operative for actuating the pump (not shown) to provide water pressure to sprayer assembly 140.

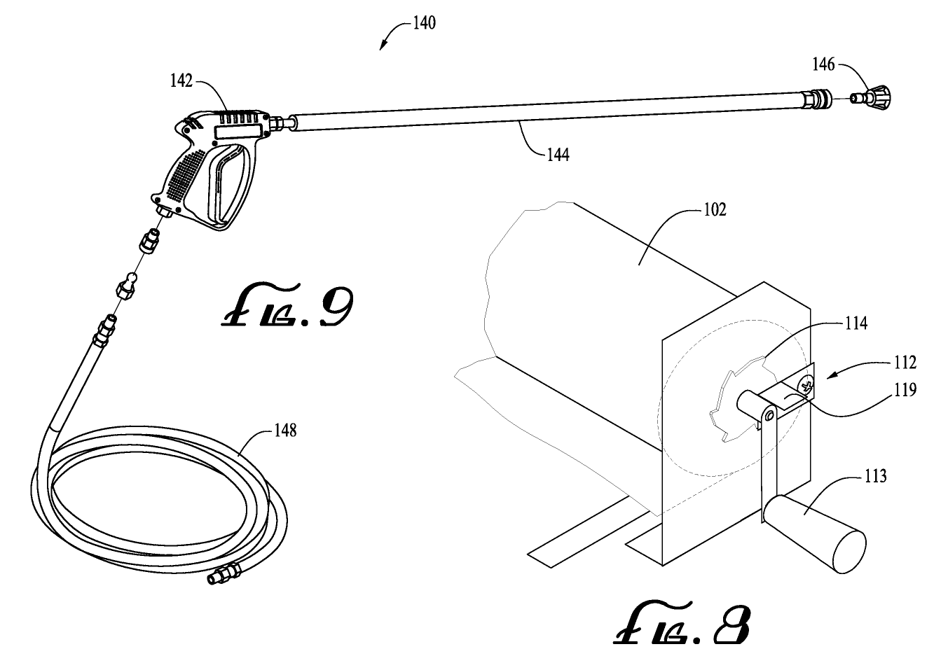

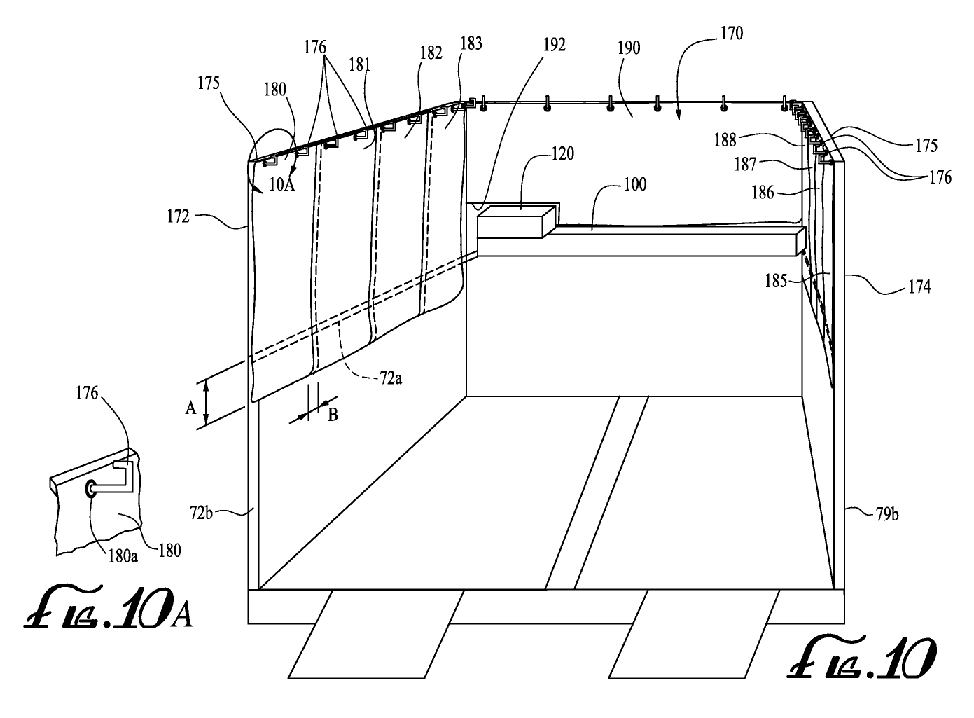

FIGS. 10-11 illustrate an optional side wall extension system 170. The extension system 170 includes vertical frame sections 172a-c, 174a-c attachable to the lower frame sections 72b, 79b, 79c/78b etc. via brackets 171a, 173a, etc. A series of hooks 176 are spaced about the inner periphery of the top portion 175 of the frame sections 172. Side tarp sections 180, 181, 182, 183 on the left side; side tarp sections 185, 186, 187, 188 on the right side; and tarp section 190 on the rear side all include eyelets that engage the hooks 176. FIG. 10A is a detail showing the eyelet 180a in tarp section 180 engaging the hook 176. The tarp sections 180-190 are preferably about 3 ft high thereby providing a significant extension to the side walls for containing splash or spray within the enclosure. The tarp sections 189-190 may be bottom-weighted to keep the sections in position during in windy conditions.

The tarp sections 180-190 are sized to hang downwardly over the side walls thereby providing a greater height for splash containment for the overall system. The rear tarp section 190 includes a cutout portion 192 for permitting access to the hose reel 120. The rear tarp section 190 is reversible to allow the location of the cutout 192 either on the left side (as in FIG. 10) or the right side (such as the hose reel location as in FIG. 1) to accommodate these alternate hose reel locations. The cutout 192 may comprise either an opening as shown or a movable flap.

The side sections 180-183 and 185-188 are formed in multiple sections, four sections per side. The side tarp sections 180-183, 185-188 extend downward past the top frame section (72a, etc.) in an overlapping fashion by an overlap “A” to ensure that water splashing on the tarp sections is directed within the interior of the wash pad. Each side tarp section is supported by three hooks 176 with adjacent side tarp sections connected to a common hook. Thus adjacent side tarp sections overlap each other by an overlap “B” of about 4 inches. Alternately, the side sections may be formed in a different number of sections (e.g., three sections or a single section). A single section is likely to be of lower manufacturing cost (primarily due to labor), but the multiple overlapping sections being smaller and lighter are more easily manipulated.

Shorter than the side tarp sections, the rear tarp section 190 extends only to the top of the tarp cover system 100 (described below) and the hose cover 120. The rear tarp section 190 is preferably formed in a single section, but may be formed in multiple overlapping sections. A multiple piece rear tarp section 190 may also be reversible to allow for either left side or right side location of the cutout 192.

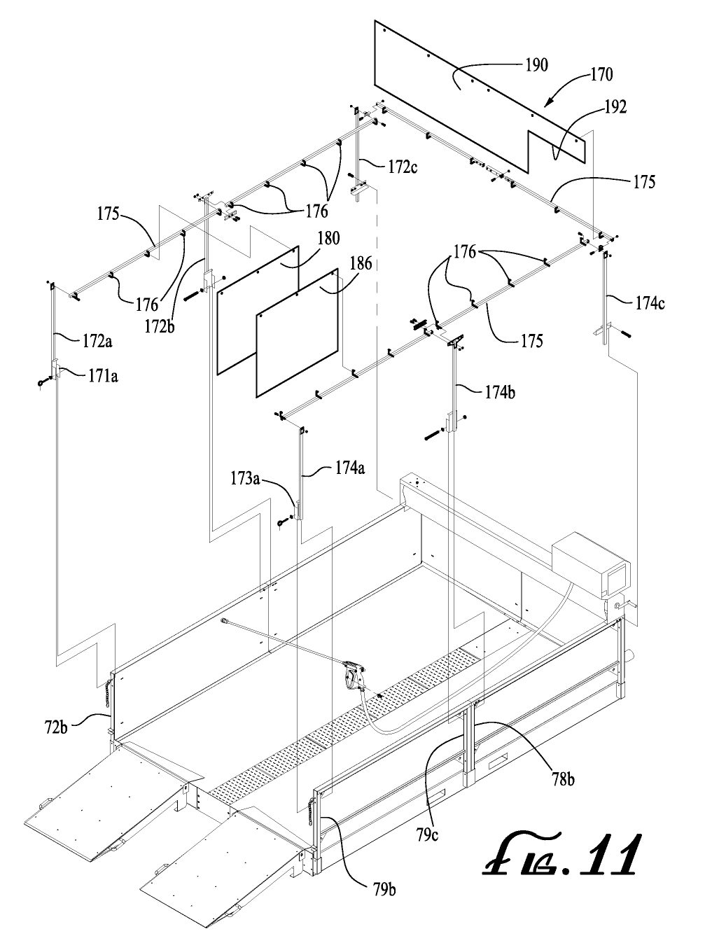

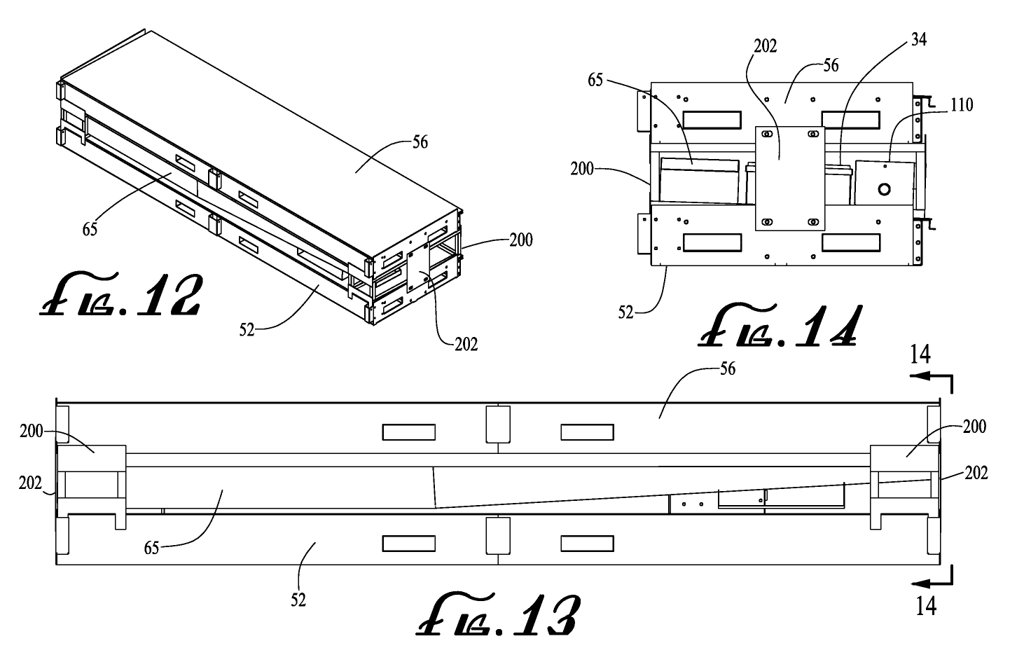

The wash pad system 40 when assembled has a fairly large footprint. FIGS. 12-14 illustrate a system and method for assembling the wash pad system 40 into a compacted assembly for a shipping mode. The compacted assembly is provided with a shipping frame 200. A first wash pad section 52 is placed on the ground. The shipping frame 200 is placed on top of the wash pad section 52. The center trench 65 is placed on top of the wash pad section 52 on the left side. Both the sump 34 and the tarp assembly 110 are placed on the right side of the wash pad section 52. Then the other wash pad section 56 is placed on the shipping frame 200 over the wash pad section 52 thereby enclosing the center trench 65, the sump 34 and the tarp assembly 110. Shipping plates 202 are bolted or screwed to and between the wash pad sections 52, 56 on opposite ends thereof to secure the pieces in place for shipping. In this compacted configuration, the entire system may fit within a standard truck trailer for shipment.

Though the present invention has been set forth in the form of its preferred embodiments, it is nevertheless intended that modifications to the disclosed systems and methods may be made without departing from inventive concepts set forth herein.

1. A wash pad and wash fluid containment system upon which items such as vehicles or equipment are positioned and supported for collecting wastewater occasioned when washing the items, comprising
a central trench;
a left side wash pad section and a right side wash pad section positioned on opposite sides of the central trench, the left and right side wash pad sections being of like configuration, each side wash pad section having a sloped surface for directing wastewater toward the central trench.

2. A system according to claim 1 wherein the left side wash pad section and a right side wash pad section are of identical configuration and interchangeable.

3. A system according to claim 1 wherein the central trench includes a sloped internal bottom surface constructed and arranged for directing wastewater toward one end thereof.

4. A system according to claim 1 wherein the central trench is constructed and arranged to be alternately positionable in either a first orientation downwardly sloping to a rear of the wash pad or a second orientation downwardly to a front of the wash pad.

5. A system according to claim 1 wherein each side wash pad section includes four sides comprising a rectangular-shaped structure, with each of the four sides having fork lift receiving openings.

6. A system according to claim 1 further comprising a grate removably positionable over the central trench and extending laterally between the left and right side wash pad sections.

7. A system according to claim 1 further comprising a first ramp section pivotally attached to the right side wash pad section, the first ramp section being pivotally movable between (a) a first operative position for allowing a vehicle to be rolled up the ramp section and onto the wash pad and (b) a second closed position.

8. A system according to claim 1 further comprising a second ramp section pivotally attached to the left side wash pad section, the second ramp section being pivotally movable between (a) a first operative position for allowing a vehicle to be rolled up the ramp section and onto the wash pad and (b) a second closed position.

9. A system according to claim 7 further comprising
a hinge connector operative between the first ramp section and the right side wash pad section, wherein the first ramp section is rotatable from the first operative position upwardly to the second closed position;
a locking mechanism for securing the first ramp section in the second closed position.

10. A system according to claim 1 further comprising
a partial side enclosure assembly disposed about an outer perimeter of three sides of the wash pad including a left side wall section connected to and extending upward from left side wash pad section, a right side wall section connected to and extending upward from right side wash pad section, and a closed rear wall section disposed at a distal end of the wash pad and extending between the left side wall section and the right side wall section.

11. A system according to claim 10 further comprising
a retractable cover assembly including
a rotatable roller mounted on the end wall section,
a tarp wrapped on the roller, the tarp being constructed and arranged to unwrap from the roller and extend over a predominant area of the wash pad, the tarp when extended forming a downward angular slope from the closed rear wall for enabling water collecting on the tarp to drain off the tarp and away from the wash pad.

12. A system according to claim 11 wherein the roller is operable to impart a taut condition on the tarp when the tarp is in the extended position for enhancing drainage of water off the tarp.

13. A system according to claim 10 further comprising an integrated pressure washer system including: a hose reel mounted on the rear wall section; a pressure hose wound onto the hose reel; a wash wand connected to the pressure hose.

14. A system according to claim 10 wherein components of the system are assembled and alternately disassembled into a compacted assembly for a shipping mode such that the entire system is constructed and arranged to fit within a standard truck trailer for shipment.

15. A wash pad and fluid containment system, comprising
a plurality of wash pad sections constructed and arranged to be assembled to form a wash pad upon which items such as vehicles or equipment are positioned and supported for collecting wastewater occasioned when washing the items;
a partial side wall enclosure assembly disposed about an outer perimeter of three sides of the wash pad including a left side wall section, a right side wall section, and a closed rear wall section disposed at a distal end of the wash pad and extending between the left side wall section and the right side wall section;
a retractable cover assembly including
a rotatable roller mounted on the rear wall section,
a tarp wrapped on the roller, the tarp being constructed and arranged to unwrap from the roller and extend over a predominant area of the wash pad, the tarp when extended forming a downward angular slope from the closed rear wall section for enabling water collecting on the tarp to drain off the tarp and away from the wash pad.

16. A system according to claim 15 wherein the roller is operable to impart a taut condition on the tarp when the tarp is in the extended position for enhancing drainage of water off the tarp.

17. A system according to claim 15 wherein the end of the tarp extending over the wash pad is securable in place, the roller including a ratchet mechanism operable to tighten the tarp into a taut condition thereby enhancing drainage of water off the tarp.

18. A system according to claim 15 wherein the retractable cover assembly further includes:
wherein the tarp includes a first tarp end connected to the roller and a free tarp end movable to extend over the wash pad,
a rod connected to the free tarp end and extending beyond a width thereof,
brackets on either side right side wall section and the left side wall section for accepting the ends of the rod,
wherein the roller includes a locking mechanism operable to impart a taut condition on the tarp when the tarp is in the extended position for enhancing drainage of water off the tarp.

19. A wash pad and fluid containment system, comprising
a plurality of wash pad sections constructed and arranged to be assembled to form a wash pad upon which items such as vehicles or equipment are positioned and supported for collecting wastewater occasioned when washing the items;
a partial side wall enclosure assembly disposed about an outer perimeter of three sides of the wash pad including a left side wall section, a right side wall section, and a closed rear wall section disposed at a distal end of the wash pad and extending between the left side wall section and the right side wall section;
a side wall extension system extending above the side walls including:
a frame connected to and extending upwardly from the side walls,
a plurality of tarp sections hanging on the frame and arranged in an overlapping fashion above the side wall enclosure assembly.

20. A system according to claim 19 wherein the side wall extension system further comprises a plurality of hooks spaced about a top portion of the frame, wherein the tarp sections include a plurality of eyelets for engaging the hooks.
